(19) United States
(12) Patent Application Publication
(10) Pub. No.: US 2026/0266109 A1
(43) Pub. Date: Sep. 10, 2026

(54) MOTOR VEHICLE LOCKING DEVICE

(71) Applicant: Kiekert Aktiengesellschaft, Heiligenhaus (DE)

(72) Inventor: Aleš KEJDANA, Prelouc (CZ)

(73) Assignee: Kiekert Aktiengesellschaft, Heiligenhaus (DE)

(21) Appl. No.: 18/876,362

(22) PCT Filed: May 17, 2023
(86) PCT No.: PCT/DE2023/100363

§ 371 Date: Dec. 18, 2024

(30) Foreign Application Priority Data
Jun. 22, 2022 (DE) 10 2022 115 500.5

(51) Int. Cl. E05B 83/24; E05B 85/26

(52) U.S. Cl. CPC E05B 83/24; E05B 85/26

(57) ABSTRACT

The invention relates to a motor vehicle locking device, in particular a motor vehicle lock, preferably a motor vehicle bonnet lock, which is equipped with a locking mechanism (1, 2) consisting substantially of a rotary latch (1) and a pawl (2). Furthermore, a release element (5) is provided for lifting out the pawl (2). By lifting out the pawl (2), the locking mechanism (1, 2) first assumes a pre-latch position and then, after the pawl (2) has been subjected to a force again, an open position. For this purpose, the pawl (2) has a sliding pin (2a) that interacts with a slot (8) on the rotary latch (1). According to the invention, the pawl (2) also has a guide pin (2b) that interacts with an outer contour (1c, 1d) of the rotary latch (1).

The invention relates to a motor vehicle locking mechanism, in particular a motor vehicle lock and preferably a motor vehicle bonnet lock, with a locking mechanism consisting substantially of a rotary latch and a pawl, and with a release element for lifting the pawl, wherein the locking mechanism first assumes a pre-engaged position by lifting the pawl and an open position after the pawl has been acted upon again, and wherein the pawl has a sliding pin interacting with a slot on the rotary latch for this purpose.

Motor vehicle locking devices generally refer to locking devices on or in motor vehicles that can be used to lock flaps, doors, seats, etc., for example. In general, this refers to motor vehicle locks and in particular motor vehicle bonnet locks, i.e. motor vehicle locks that are used in particular to lock bonnets, doors or flaps on or in motor vehicles against the motor vehicle body. Motor vehicle bonnet locks actually refer to motor vehicle locks on front hoods or tailgates, for example.

Such motor vehicle bonnet locks, which are used, for example, in connection with the locking of a motor vehicle front hood or a motor vehicle tailgate, are usually opened from the interior of an associated motor vehicle. For example, a Bowden cable ending inside the motor vehicle can operate on a release lever as a release element and ensure the unlocking or aperture of the associated motor vehicle bonnet lock. The actuating device used at this point can be a handle or a loop for manual actuation. In principle, however, electromotive actuation of the release lever or release element is also possible and is also covered by the invention.

Although motor vehicle bonnet locks can generally be opened in the manner described, they are only opened to a gap due to spring force and for safety reasons. This is necessary, for example, to prevent the front hood of the motor vehicle from swinging open completely if the actuating device is actuated incorrectly while driving, which can lead to a dangerous obstruction of a driver's view.

The complete aperture of the motor vehicle hood from this gap position is usually and in practice carried out with the aid of a catch lever, which must be pivoted by an operator for this purpose and when the associated motor vehicle is stationary. Only then is the hood or front hood finally released. In the open position of the locking mechanism, the catch lever in question engages around or over the locking bolt attached to the front hood of the motor vehicle.

Such a catch lever and the associated mechanism are not required if, when unlocking the motor vehicle lock in question, it is ensured or can be ensured that the pre-locking position of the locking mechanism, for example, is reliably assumed by the unlocking process. The aperture can then be opened in connection with this by manually swiveling the pawl out of this pre-locking position on the rotary latch and thus opening the front hood of the motor vehicle as a whole. The prerequisite for this, however, is the safe assumption of the pre-locking position.

The generic prior art according to DE 103 61 186 B4 relates to a motor vehicle lock and in particular a motor vehicle bonnet lock in which a so-called snow load function is to be realized. This snow load function means that if the relevant cover is loaded with snow, the cover will not open into the gap position even if the pawl is lifted from its engagement with the rotary latch using the release element. This is because the snow load can cause the cover in question to be closed again unintentionally.

For this purpose, the teaching referred to proposes a motor vehicle lock and, in particular, a motor vehicle bonnet lock, in which an effective latching connection is realized between the rotary latch and the pawl by means of a latching connection element and a latching connection counter element.

The latching connection element can be brought into latching engagement with the latching connection counter element in the main closed position. Disengagement is observed in the direction of the opening position. A relatively complicated mechanism is provided for this purpose, because the latching connection element is arranged or formed on a spring arm on the pawl, which lies in a plane to the side of the rotary latch.

DE 10 2016 010 467 A1 also involves an interaction between the rotary latch and the pawl. In this case, a tracking lever is assigned to the pawl or the rotary latch, by means of which a locking surface or a counter-locking surface can be tracked in such a way that the rotary latch swivels in the opening direction over a defined swivel angle without the locking surface and the counter-locking surface becoming disengaged. This is intended to counteract noise development during the opening process.

In the further state of the art according to WO 2021/190684A1 , which can be traced back to the applicant, it is provided in a hood lock that the pawl, which is lifted from a main detent of the rotary latch with its first locking tooth by means of the release lever for unlocking, interacts with its second locking tooth with the main detent of the rotary latch for forced guidance of the pawl and blocking of the pre-locking of the rotary latch during the opening process of the locking mechanism. In this manner, it is ensured that the pre-locking position is safely assumed during unlocking. Consequently, to open the known motor vehicle bonnet lock in question, a double actuation or so-called double stroke of the release lever is required. This has basically proven its worth in order to ensure that the known motor vehicle lock securely assumes the pre-locking position on the one hand and can then be opened from the pre-locking position by pivoting the pawl again on the other.

The present invention is based on the technical problem of further developing such a motor vehicle locking device in such a manner that a structurally simple and compact structure is observed while retaining the described functionality, i.e. safe assumption of the pre-locking position.

To solve this technical problem, a generic motor vehicle locking device within the scope of the invention is characterized in that, in addition to the sliding pin already described, the locking pawl also has a guide pin interacting with an outer contour of the rotary latch.

This means that, according to the invention, the pawl is equipped with two pins, namely the sliding pin which interacts with the slot on the rotary latch on the one hand and additionally the guide pin which interacts with the outer contour of the rotary latch on the other hand. In this manner, an opening process of the motor vehicle locking device according to the invention can be realized and implemented in a particularly simple manner, wherein the pre-locking position is first safely assumed in accordance with the teaching according to WO 2021/190684A1 . Only in connection with a further actuation of the release element to lift the locking pawl is the pre-locking position of the locking mechanism released and the locking mechanism then assumes its opening position. In particular, this means that the otherwise usual and obligatory catch lever can usually be dispensed with and the motor vehicle locking device according to the invention can be opened both manually and by electric motor.

In addition, the shape of the two pins on the pawl corresponds to a particularly compact structure. This is because the slot on the rotary latch is typically designed as a sliding pin recess into which the sliding pin plunges. Accordingly, there is at least a partial overlap between the pawl and the rotary latch (top view), which favors the desired compact structure.

In addition, the design is often such that the sliding pin and the guide pin are arranged on a respective sliding arm and guide arm of the pawl. The two pins are preferably located at the end of the associated arm. In addition, the design is usually such that the two arms with the pins between them form an acute angle.

The two arms can each be arranged with the pins opposite a bearing recess in the pawl. In most cases, the two arms with the pins run mostly radially in relation to an axis of rotation of the pawl. The axis of rotation of the pawl is defined by the fact that a bearing pin plunges into the bearing recess of the pawl, thus defining the axis of rotation in question. Consequently, the two arms with the pins also run mostly radially in relation to the bearing recess or the bearing pin in question.

The sliding pin recess is generally equipped with at least one pre-locking stop in order to ensure that the pre-locking position or pre-locking position of the locking mechanism according to the invention is correctly and safely engaged. In most cases, two pre-latching stops are provided at this point, offset to one another. The two pre-latching stops can be radially offset in relation to an axis of rotation of the rotary latch. In this manner, it is possible for the two pre-latching stops to separate a pre-latching passage and an opening passage of the sliding pin recess.

If the motor vehicle locking device according to the invention, and in particular the motor vehicle lock, is opened starting from a main locking position or main latching position, the sliding pin of the pawl first moves along the pre-latching passage until the sliding pin reaches one of the two pre-latching stops. In most cases, the design is such that the sliding pin in question moves against the first pre-engagement stop, which is located radially on the outside compared to the axis of rotation of the rotary latch inside the sliding pin recess. As soon as the pawl is released in this position or the release element is no longer actuated to lift the pawl, the sliding pin usually moves against the second pre-engagement stop, which is located radially inwards in relation to the axis of rotation of the rotary latch. This is usually ensured by a spring that pushes the pawl into its closed position.

If, starting from this pre-locking position, the locking pawl is now acted upon again-in a second stroke-in the “open” direction, the locking pawl can, starting from the second and radially inner pre-locking stop inside the sliding pin recess, plunge into the opening passage of the sliding pin recess and move along this opening passage to an opening stop. This is ensured by the spring force acting on the rotary latch in the opening direction. This spring force may result from a spring assigned to the rotary latch and pretensioned in the opening direction and/or from spring forces structured by door rubber sealing forces.

In any case, there is a double-stroke actuation of the release element, wherein the locking mechanism safely assumes and maintains its pre-locking position after the first stroke. Only when the release element and with it the pawl have been relieved and a second stroke actuation takes place can the sliding pin move into the opening passage and the rotary latch reaches its overall opening position to release the locking bolt. In this manner, a particularly functional operation of the motor vehicle lock according to the invention and in particular motor vehicle bonnet lock is provided. This all sounds like a simple and compact structure.

This is complemented by the fact that both the sliding pin and the guide pin are typically designed as folded edges on the pawl and can therefore be easily defined during the forming process of the pawl. In fact, according to the invention, the pawl is punched out and then or simultaneously bent with respect to the two pins. High-strength steel is usually used as the material. The same applies to the rotary latch, which is also made of high-strength steel and only needs to be fitted with the sliding pin recess for adaptation to the invention gauge. This can be easily inserted into the rotary latch during a punching process.

The result is a motor vehicle locking device with a compact and functionally reliable structure. The interaction of the sliding pin with the sliding pin recess on the one hand and the guide pin with the outer contour of the rotary latch on the other ensures that the sliding pin inside the sliding pin recess first completes the pre-latching passage up to one or both pre-latching stops. In connection with a second actuation of the release element, the sliding pin can then move into the opening passage of the sliding pin recess. This is additionally ensured by the guide pin that lies against the outer contour of the rotary latch. These are the main advantages.

In the following, the invention is explained in more detail with the aid of a drawing showing only an exemplary embodiment; in the figures:

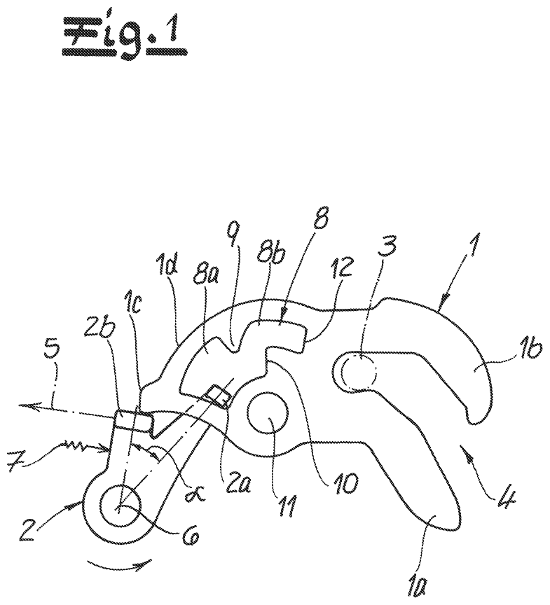

FIGS. 1 to 3 show the vehicle closing device according to the invention during an opening process starting from the main closing position up to the first radially outer pre-latching stop,

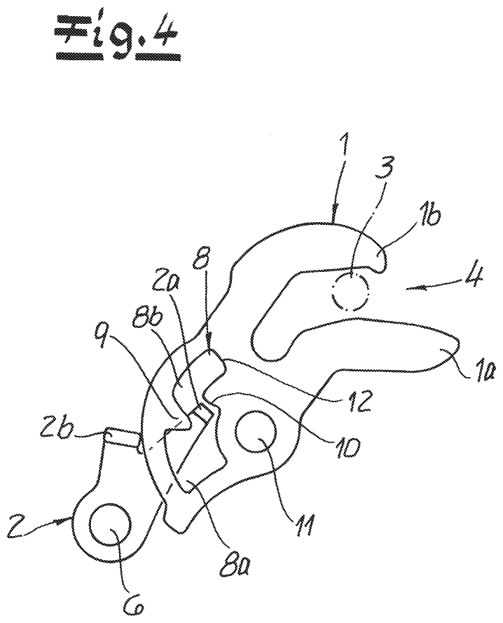

FIG. 4 shows the transition to the second pre-latching stop and

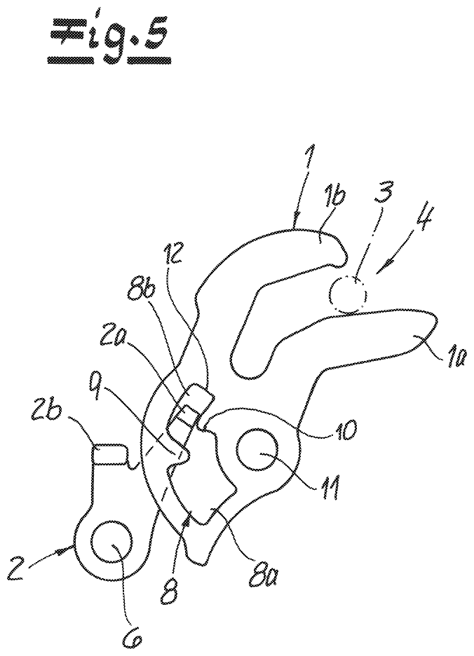

FIG. 5 shows the path of the sliding pin along the opening passage and

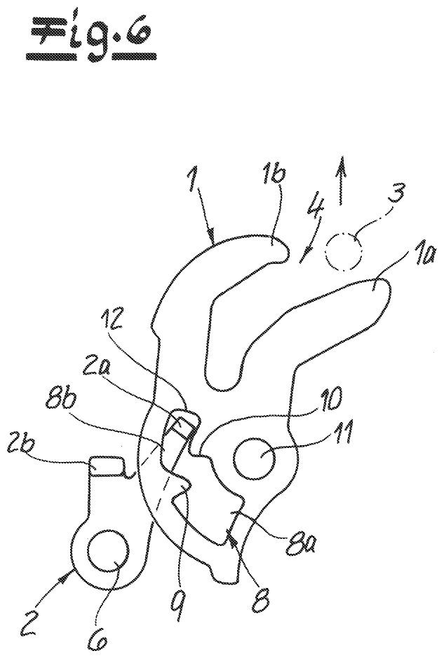

FIG. 6 shows the fully open position with the sliding pin in contact with the opening stop.

The figures show a motor vehicle locking device which, in the context of the embodiment example, is a motor vehicle lock and preferably a motor vehicle bonnet lock. This is equipped with a locking mechanism 1, 2 consisting substantially of rotary latch 1 and pawl 2. The figures also show a locking bolt 3, which is caught by the rotary latch 1 in the main closed position or main latching position as shown in FIG. 1 and is released in the open position as shown in FIG. 6. For this purpose, the locking bolt 3 is received in an inlet mouth 4 of the rotary latch 1, which in turn defines the inlet mouth 4 in question with two fork-shaped arms, namely a stop arm 1a and a catch arm 1b.

In addition, a merely indicated release element 5 is provided for lifting the pawl 2. For this purpose, the release element 5 acts on the pawl 2 in such a way that the pawl 2 is acted upon to open about its axis 6 in the counter-clockwise direction indicated in FIG. 1, namely against the force of a spring 7, which in contrast acts upon the pawl 2 in a clockwise direction in relation to the axis or axis of rotation 6.

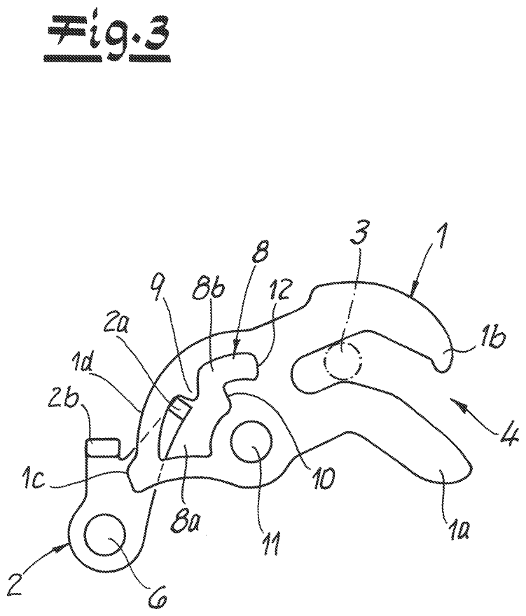

The release element 5 can be activated manually by actuating the release element 5 via a Bowden cable (not shown) or another flexible connecting element using a handle. In principle, an electromotive actuation of the release element 5 is also conceivable. In the context of the invention, a double-stroke actuation is used, namely in that the pawl 2 is first simply pivoted counterclockwise about its axis of rotation 6 by a first stroke until the pre-locking position corresponding to FIG. 3 or FIG. 4 has been reached. Starting from the pre-locking position there, a renewed second actuation of the pawl 2 with the aid of the release element 5 by actuating the pawl 2 counterclockwise around its axis 6 ensures that the opening position is finally reached after this two-stroke actuation as shown in FIG. 6.

In order to realize and implement this in detail, the pawl 2 has a sliding pin 2a interacting with a slot 8 on the rotary latch 1. According to the embodiment example and in accordance with the invention, in addition to this sliding pin 2a, a further guide pin 2b is also realized on the pawl 2, which interacts with an outer contour 1c, 1d of the rotary latch 1. As already explained in the introduction, both pins 2a, 2b are each produced and realized by punching out the pawl 2 and defining the respective pins 2a, 2b by bending associated arms at the ends.

According to the embodiment example, the slot 8 on the rotary latch 1 is designed as a sliding pin recess 8, into which the sliding pin 2a plunges. It can be seen that the sliding pin recess 8 can be divided into a pre-latching passage 8a and an opening passage 8b, which are explained in more detail below.

It can also be seen that the sliding pin 2a and the guide pin 2b are arranged on a respective associated sliding arm and guide arm of the pawl 2, in each case on the end side. The two arms with the end studs 2a, 2b enclose an acute angle a between them, which is only indicated in FIG. 1. In addition, the design is such that the two arms with the pins 2a, 2b are each arranged opposite a bearing recess of the pawl 2 defining the axis or axis of rotation 6. In fact, the design is such that the two arms with the respective end pins 2a, 2b are largely radial in relation to the axis of rotation 6 of the pawl 2 in question.

The sliding pin recess 8 is equipped with at least one pre-latching stop 9, 10. In fact, two pre-latching stops 9, 10 are realized within the scope of the embodiment example, namely the first pre-latching stop 9 and the second pre-latching stop 10. The first pre-latching stop 9 is arranged radially on the outside in relation to the axis or axis of rotation 11 of the rotary latch 1, whereas the second pre-latching stop 10 is arranged radially on the inside in relation to the axis of rotation 11 of the rotary latch 1. It can also be seen that the two pre-engagement stops 9, 10 are radially offset in relation to the axis of rotation 11 of the rotary latch 1. In this manner, the two pre-latching stops 9, 10 together separate the previously mentioned pre-latching passage 8a from the opening passage 8b for the sliding pin 2a of the pawl 2.

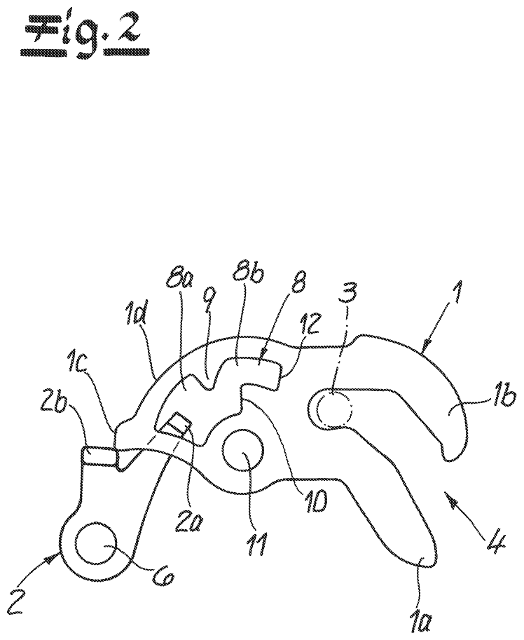

The mode of operation is as follows. FIG. 1 shows the locking mechanism 1, 2 in its main closed position or main latching position. If, starting from this main closed position, the release element 5 is now acted upon to lift or pivot the pawl 2 counterclockwise about the axis 6, this results in the sliding pin 2a within the pre-latching passage 8a initially also pivoting counterclockwise about its axis of rotation 6, namely into the position shown in FIG. 2.

Starting from the position shown in FIG. 2, the rotary latch 1—acted upon by spring forces in an anticlockwise direction around its axis or axis of rotation 11—can now pivot until the sliding pin 2a reaches the first pre-engagement stop 9, as shown in FIG. 3. This is possible because the counterclockwise pivoting movement of the pawl 2 about its axis of rotation 6 corresponds to the guide pin 2b on the pawl 2 leaving a lug 1c of the rotary latch 1, allowing the rotary latch 1 to pivot counterclockwise about its axis 11 as a result of the spring forces during the transition from FIG. 1 to FIG. 2 and on to FIG. 3. The nose 1c of the rotary latch 1 is a component of the outer contour 1c, 1d.

Now the sliding pin 2a is in contact with the first pre-engagement stop 9, which is located radially on the outside in relation to the axis of rotation 11 of the rotary latch 1. During the transition from FIG. 3 to FIG. 4, a release of the release element 5 now causes the pawl 2—acted upon by its spring 7—to pivot clockwise about its axis 6, starting from the representation in FIG. 3, until the sliding pin 2a rests against the second pre-engagement stop 10, which is arranged radially inwards in relation to the axis of rotation 11 of the rotary latch 1. This is possible because during the transition from FIG. 3 to FIG. 4, the rotary latch can again rotate-slightly-counterclockwise around its axis 11 due to the spring forces acting on it. At the same time, the guide pin 2b in contact with a curved contour 1d as part of the outer contour 1c, 1d of the rotary latch 1 ensures that the sliding pin 2a safely reaches the second pre-engagement stop 10. Now the locking mechanism 1, 2 safely and theoretically permanently assumes its pre-locking position as shown in FIG. 4. The release element 5 is not acted upon in the same manner as the pawl 2.

In order to be able to finally open the locking mechanism 1, 2 from this pre-locking position as shown in FIG. 4, it is necessary to swivel the pawl 2 counterclockwise around its axis 6 again using the release element 5 as shown in FIG. 4. This can be seen in the transition from FIG. 4 to FIG. 5. This process corresponds to the sliding pin 2a entering the opening passage 8b of the sliding pin recess 8 on the one hand and the sliding pin 2b leaving the outer contour 1c, 1d of the rotary latch 1 on the other. Starting from the position shown in FIG. 5, the rotary latch 1 can now continue to swing open counterclockwise around its axis 11 due to the spring forces acting on it, until the sliding pin 2a moves against an opening stop 12 inside the sliding pin recess 8. The rotary latch 1 is now fully open and releases the locking bolt 3 emerging from the inlet mouth 4. The associated hood can be easily swung open by a user.

### LIST OF REFERENCE SIGNS

1,2 locking mechanisms
1 rotary latch
1a stop arm
1b catch arm
1c nose
1d arc contour
1c, 1d outer contour
2 pawl
2a sliding pin
2b guide pin
3 locking bolt
4 inlet mouth
5 release element
6 axis or axis of rotation
7 spring
8 sliding pin, sliding pin recess
8a pre-latching passage
8b opening passage
9 First pre-latching stop
10 second pre-latching stop
11 axis or axis of rotation
12 opening stop
α acute angle

1. A motor vehicle locking device comprising:
a locking mechanism including a rotary latch and a pawl, and
a release element for lifting the pawl, wherein the locking mechanism initially assumes a pre-engaged position by lifting the pawl and an open position after renewed actuation of the pawl,
wherein the pawl has a sliding pin interacting with a sliding pin recess on the rotary latch, and
wherein the pawl additionally has a guide pin interacting with an outer contour of the rotary latch.

2. The motor vehicle locking device according to claim 1, wherein the sliding pin recess on the rotary latch is designed as a slot into which the sliding pin plunges.

3. The motor vehicle locking device according to claim 1, wherein the sliding pin and the guide pin are arranged respectively on an end side of a sliding arm and guide arm of the pawl.

4. The motor vehicle locking device according to claim 3, wherein the sliding arm with the sliding pin and the guide arm with the guide pin enclose an acute angle between the sliding arm and the guide arm.

5. The motor vehicle locking device according to claim 3, wherein the sliding arm with the sliding pin and the guide arm with the guide pin are each arranged opposite a bearing recess of the pawl.

6. The motor vehicle locking device according to claim 3, wherein the sliding arm with the sliding pin and the guide arm with the guide pin extend radially in relation to an axis of rotation of the pawl.

7. The motor vehicle locking device according to claim 1, wherein the sliding pin recess has at least one pre-engagement stop for engaging the locking mechanism in the pre-engaged position.

8. The motor vehicle locking device according to claim 7, wherein the at least one pre-engagement stop comprises two pre-engagement stops which are arranged offset relative to one another.

9. The motor vehicle locking device according to claim 8, wherein the two pre-engagement stops are radially offset with respect to an axis of rotation of the rotary latch.

10. The motor vehicle locking device according to claim 8, wherein the two pre-engagement stops separate a pre-latching passage and an opening passage of the sliding pin recess from one another.

11. The motor vehicle locking device according to claim 10, wherein when the locking mechanism transfers from a main latching position to the pre-engaged position, the sliding pin of the pawl moves along the pre-latching passage until the sliding pin reaches a first one of the two pre-engagement stops, and when the pawl is released the sliding pin moves against a second one of the two pre-engagement stops.

12. The motor vehicle locking device according to claim 11, wherein the first one of the two pre-engagement stops is located radially on an outside compared to an axis of rotation of the rotary latch inside the sliding pin recess, and the second one of the two pre-engagement stops is located radially inwards in relation to the axis of rotation of the rotary latch.

13. The motor vehicle locking device according to claim 1, further comprising a spring that acts on the pawl in an opening direction.

14. The motor vehicle locking device according to claim 1, wherein the sliding pin and the guide pin are configured as folded edges of the pawl.
